(19) United States
(12) Patent Application Publication
(10) Pub. No.: US 2022/0129977 A1
(43) Pub. Date: Apr. 28, 2022

(54) ONLINE TOKENIZATION OF OUTSTANDING DEBT

(71) Applicant: Good Life Networks Inc., Vancouver (CA)

(72) Inventor: Christopher BRADLEY, Durham (GB)

(21) Appl. No.: 16/971,929

(22) PCT Filed: Feb. 22, 2019
(86) PCT No.: PCT/CA2019/050219

§ 371 Date: Jan. 14, 2021

Related U.S. Application Data
(60) Provisional application No. 62/634,333, filed on Feb. 23, 2018.

(51) Int. Cl. G06Q 40/02; G06Q 30/02; H04L 9/32

(52) U.S. Cl. CPC G06Q 40/025; G06Q 30/02; H04L 2209/56; H04L 2209/38; H04L 9/3213

(57) ABSTRACT

Systems and methods relating to accounts receivables and blockchain technology. Accounts receivables are tokenized by having an investor pay for a portion of the account receivable debt in exchange for a fixed return. In addition to the fixed return, the investor is then provided with a token that details the entities involved in the debt, the fixed return, the portion of the debt paid for, and the date of expected payment for the debt. These details are also recorded in a blockchain data structure that is continuously replicated by blockchain miners.

### TECHNICAL FIELD

The present invention relates to corporate debt management. More specifically, the present invention relates to systems and methods for managing a company's accounts receivable.

### BACKGROUND

In the business world, accounts receivables are the lifeblood of companies. Businesses have to manage their receivables and to balance these with their accounts payable. Unfortunately, there is a time gap between the time that a service is rendered to a customer and the time when the customer pays the invoice for that service. Typically, this time gap can be as much as 90 to 120 days. In some industries, any receivables that are older than 90 days are already considered as being bad debts.

One issue with such a time gap is that businesses have to continue operating during that 90 or so days before the customer pays invoices. Bills are incurred, employees have to be paid, and suppliers have to be paid. To this end, quite a few businesses have taken to accepting a loss on their receivables in exchange for quicker payment. Credit facilities (e.g. Silicon Valley Bank) or factoring companies (e.g. FastPay) will pay a company most of a receivable in exchange for a substantial portion of that receivable. As an example, one can assume a $100 debt that company A owes to company B. Company A expects to pay company B that amount in 90 days. Company B, to be paid sooner, uses credit facilities or factoring companies. Company B is paid within 14 days by the credit facility in exchange for up to 27% of the receivable. This means that, instead of receiving the $100 (in 90 days) that it is owed, company B only receives $73 within 14 days of the debt being incurred while the credit facility or the factoring company keeps the remaining $27. Of course, when company A pays the $100 in full, the credit facility or factoring company receives the $100, with $73 dollars in payment of what was paid out to company A and the remaining $27 as its fee for acting as a credit facility.

While the above is fairly standard business practice in many industries, in the field of online advertising, this issue of can be quite acute. Online advertising publishers need to pay for regular quality content creation to grow their audience. However, the delay in payment can be problematic, especially given that advertisers essentially enjoy the benefits of the advertising on their behalf well before they ever pay for the service. As noted above, publishers can use credit facilities or factoring companies. However, it can easily be argued that losing up to almost a third of one's receivables is a bad business practice.

From the above, there is therefore a need for system and methods that address the above issues while mitigating the drawbacks of the current art.

### SUMMARY

The present invention provides systems and methods relating to accounts receivables and blockchain technology. Accounts receivables are tokenized by having an investor pay for a portion of the account receivable debt in exchange for a fixed return. The accounts receivable holder is paid the funds that the investor paid for the portion of the debt. In addition to the fixed return, the investor is then provided with a token that details the entities involved in the debt, the fixed return, the portion of the debt paid for, and the date of expected payment for the debt. These details are also recorded in a blockchain data structure that is continuously replicated by multiple blockchain miners. Upon full payment of the accounts receivable debt, the holder of the token is paid back the amount that was originally paid for the portion of the debt as well as the fixed return. The entity providing the service of tokenizing the debt then keeps the remaining portion of the full payment. By carefully managing the percentages or portions of the debt, including the tokenized amount as well as the fixed return, companies can avoid the issue of paying too much of a percentage of its existing receivables for earlier payment.

In a first aspect, the present invention provides a method for managing an accounts receivable debt between a first party and a second party, the debt being owed by said first party to said second party, the method comprising:
a) receiving an indication that said debt exists, said indication including an amount for said debt;
b) adding a record of said debt to a blockchain data structure;
c) determining a settlement price for said debt, said settlement price being less than a full amount for said debt;
d) settling said debt for said settlement price such that at least a portion of funds paid for said settlement price are funds invested by at least one third party;
e) receiving said full amount for said debt from said first party;
f) sending a portion of said full amount to said at least one third party as a predetermined return;
g) recording details and results of steps c)-f) in at least one entry in said blockchain data structure;

wherein said blockchain data structure and its contents are continuously replicated across a plurality of networked data processing devices.

In another aspect, the present invention provides a system for managing at least one debt between a first party and a second party, said second party being owed said debt by said first party, the system comprising:

a main server for:
receiving an indication that said debt exists, said indication including a full amount for said debt;
adding a record of said debt to a blockchain data structure;
managing at least one token having a monetary value such that transactions regarding said at least one token are recording in said blockchain data structure;
managing said debt between said first party and said second party such that said debt is settled for an amount that is less than said full amount for said debt;

wherein said at least one token indicates funds invested by at least one third party and said funds are used to at least partially settle said debt.

In a further aspect, the present invention provides computer readable media having encoded thereon computer readable and computer executable instruction that, when executed, implements a method for managing an accounts receivable debt between a first party and a second party, the debt being owed by said first party to said second party, the method comprising:

a) receiving an indication that said debt exists, said indication including an amount for said debt;

b) adding a record of said debt to a blockchain data structure;

c) determining a settlement price for said debt, said settlement price being less than a full amount for said debt;

d) settling said debt for said settlement price such that at least a portion of funds paid for said settlement price are funds invested by at least one third party;

e) receiving said full amount for said debt from said first party;

f) sending a portion of said full amount to said at least one third party as a predetermined return;

g) recording details and results of steps c)-f) in at least one entry in said blockchain data structure;

wherein said blockchain data structure and its contents are continuously replicated across a plurality of networked data processing devices.

In one aspect, the present invention provides a method for managing an accounts receivable debt between a first party and a second party, the debt being owed by said first party to said second party, the method comprising:

a) receiving an indication that said debt exists, said indication including an amount for said debt;

b) adding a record of said debt to a blockchain data structure;

c) offering a portion of said debt for sale for a price in exchange for a predetermined future return, said price being equal in value to said portion of said debt;

d) adding at least one record detailing results of step c) to said blockchain data structure;

e) accepting an offer for said portion of said debt from a third party;

f) receiving funds for said portion of said debt from said third party and sending a token to said third party, said token including details of said debt, said price, and said predetermined future return, said funds being equal in value to said price;

g) sending at least a portion of said funds received from said third party to said second party;

h) receiving full payment for said debt from said first party;

i) sending a first portion of said payment to a holder of said token, said first portion of said payment being equal in value to said funds received from said third party in step f);

j) sending a second portion of said payment to said holder of said token, said second portion of said payment being equal in value to said predetermined future return;

wherein said blockchain data structure and its contents are continuously replicated across a plurality of networked data processing devices.

### BRIEF DESCRIPTION OF THE DRAWINGS

The embodiments of the present invention will now be described by reference to the following figures, in which identical reference numerals in different figures indicate identical elements and in which:

FIG. 1 is a block diagram illustrating one implementation of the present invention;

FIG. 2 is a flowchart detailing the steps in a method according to one aspect of the present invention; and

FIG. 3 is a block diagram of a variant of the present invention.

### DETAILED DESCRIPTION

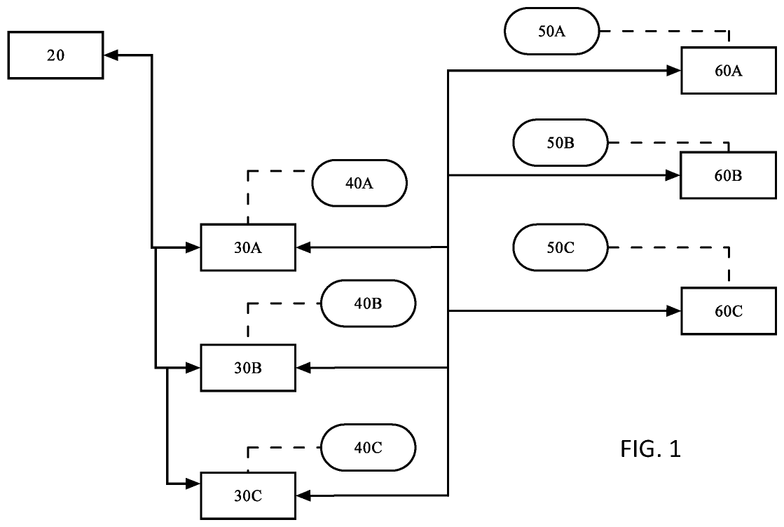

Referring to FIG. 1, a block diagram of a system according to one aspect of the invention is illustrated. As can be seen, the system 10 includes a main server 20 that is in communication with accounting servers 30A, 30B, 30C. Each of these accounting servers 30A, 30B, 30C is operated by a separate entity 40A, 40B, 40C. These entities provide services to other entities 50A, 50B, 50C. Each of these entities 50A, 50B, 50C has servers 60A, 60B, 60C that are in communication with accounting servers 30A, 30B, 30C. Once services have been provided, accounting servers 30A, 30B, 30C send invoices to servers 60A, 60B, 60C evidencing that entities 50A, 50B, 50C owe funds to entities 40A, 40B, 40C. In the normal course of business, entities 50A, 50B, 50C transfer funds to these entities 40A, 40B, 40C in payment of these debts and the relevant servers balance their books in due course. Of course, as noted above, this may take months before the entities 40A, 40B, 40C are paid by the entities 50A, 50B, 50C receiving the services. For clarity, this description will refer to the entities owing money to be the first parties while the entities being owed money will be referred to as the second parties.

In operation, the present invention operates by having the accounting servers 30A, 30B, 30C send debts owing to them to main server 20. The notification would include how much is owed to each entity, by whom (i.e. who owes them money), and when payment is expected. The main server 20 can then determine which debts are suitable for tokenization or which debts can be used with the invention. The main server 20 may apply a number of filters to determine which debts of the entities 40A, 40B, 40C are suitable. The filters may be configured to, essentially, manage the risk or determine the riskiness of the debt to be tokenized. The filters may take into account the entity that owes the funds, the history of that entity that owes the funds (e.g. has the entity/company been in existence for years or is it fairly new?), the credit history of that entity (e.g. does that entity/company have a lot of outstanding debts that have remained unpaid?), and maybe even the location of that entity (e.g. is the entity located in a developing world vs. a developed country?). Similarly, the main server may also take into account the amount of the debt between the entity owed funds and the entity owing the funds. As an example, a very large single debt between a second party (e.g. entity 40A) and a first party (e.g. entity 50A) might not be suitable if that is the only debt between the two entities. Or, similarly, a number of smaller debts between the two entities might be more suitable for tokenization as the risk is spread out across different invoices. The main server 20 may even consolidate a second party's overall debt (or a fraction of that overall debt) owed by a number of first parties into a single bundle that can be tokenized. Thus, instead of having entity 40A be owed $40 by entity 50A, $50 by entity 50B, and $60 by entity 50C, the main server 20 may bundle so that a single debt of $150 is owed to entity 40A by the various entities 50A, 50B, 50C.

Once the main server 20 has determined which debts are to be tokenized (preferably on a per debt entity basis), the main server 20 then determines how much of that debt owed to a single entity is to be used in the invention. It should be clear that only a portion or percentage (i.e. never 100%) of the debt is to be tokenized. Depending on the implementation, a formula may be applied that takes into account the amount of the debt, the expected payment period for the debt (i.e. when the debt is expected to be paid), and perhaps a numerical credit worthiness score for the entity owing the debt. Thus, as an example, if entity 50A owed $50 to entity 40A, and entity 50A is a large, well-known, and credit worthy entity (e.g. Google), then up to a maximum of 80% of the $50 debt it owes to entity 40A may be tokenized. However, a much smaller company that is not as credit worthy may only have 50% of the debt it owes to entity 40A may be tokenized. Again, this assessment may be executed to balance risk between those investing in the scheme and those to whom debt is owed.

With the portion of the debt to be tokenized being determined, a rate of return may then be determined by the main server 20. This is the amount or portion that an investor may expect to receive once the debt has been paid. Again, this may take into account the history of the entity owing the debt, the credit worthiness of that entity, as well as the expected time for payment of the debt. As an example, the debt owed by a very credit worthy entity that expects to pay the debt within a month may have a lower rate of return (i.e. a smaller percentage of the debt) than a debt owed by a less credit worthy entity that expects to pay the debt in two or even three months. A more concrete example would be a debt for $500 owed by a credit worthy entity which is expected to be paid in a month. A rate of return under these conditions might be a 5% return on the total debt, i.e. the investor would receive $25 once the debt has been paid. Conversely, a debt for $500 owed by a lesser credit worthy entity which expects to pay the debt in two months might have a rate of return that is 7.5% to 10% of the total debt, i.e. the investor would receive $37.50 to $50 once the debt has been paid. It should, however, be noted that a variable rate of return on different debts might not be implemented. The main server 20 may simply apply a fixed rate of return on all debts that it deems suitable and acceptable for use with the invention. As an example, a fixed return of 5% of the total debt may be applied, i.e. on a debt of $1000, the investor will expect a return of $50 once the debt has been paid, regardless of who owes the debt and when payment is expected. Of course, it should be noted that the rate of return need not be pegged or indexed based on the total debt. It may be indexed to the amount being tokenized. As an example, for a $100 debt of which 80% is tokenized, the rate of return may be 10%. This would mean that an investor would expect an $8 return if the rate of return is based on the amount tokenized and not on the amount of the total debt.

With the amount to be tokenized already determined as well as the rate of return, the main server 20 can then offer the package to investors. The package would include the amount needed (i.e. the amount of the debt and the portion to be tokenized), the expected payment data, and the rate of return. Depending on the implementation, the identity of the entities involved may also be attached as part of the package. As an alternative, an indication of the creditworthiness of the entities involved may be attached in place of the identity of the entities involved. As an example, a token would indicate if the entities involved are Tier 1 companies or Tier 2 or Tier 3 companies, with Tier 1 companies being the most creditworthy. Thus, in one example, the main server 20 would issue a package for a $100 debt of which 80% was tokenized, meaning that an investor would need to put in $80 as an investment. Since the debt is expected to be paid in 2 months with a rate of return that is 5% of the total debt, then the investor would expect $5 in return in 2 months' time. If the rate of return is based on the tokenized amount, then a 5% rate of return would mean a return of $4 in 2 months' time.

An investor 70 can receive the offer and, if attractive, can provide the amount needed per the package. It should be noted that the investor could provide the whole amount needed for the tokenized amount and, in return, the investor would receive a token evidencing the details of the transaction. The token would thus have the amount tokenized, the rate of return, possibly the amount of the debt, and the date of the expected payment. As well, the token may include the identity of the entities involved or an indication of the creditworthiness of the entities involved. Alternatively, the investor could provide a portion of the tokenized amount and the token would indicate the tokenized amount, the portion that the investor provided funds for, as well as the rate of return and the other details noted above. Similarly, multiple investors can simply pool their funds to provide a pooled fund and the fund would receive the token (or multiple tokens) detailing the information noted above. Each investor would thus receive a prorated amount of the profit based on the percentage of the pooled fund that the investor provided. It should be clear that, in this document, the term “investor” includes the concept of multiple investors and/or the concept of a pool of investors who provide the monies necessary for a pooled fund.

Once the investor receives the offer and accepts it, the amount indicated in the token is then forwarded to the operator of the main server and an indication of this payment is sent to the main server as well. The main server then causes the forwarding of this amount to the entity to whom funds are owed. The transaction, as well as all of its details, is then recorded in a blockchain data structure stored in the servers operated by the debt owning entities 40A, 40B, 40C. Entering a blockchain entry into the blockchain data structure on one of the servers causes the other servers to copy and validate that entry into their own copy of the blockchain data structure. Of course, the blockchain data structure may be stored in servers owned and/or operated by entities other than the debt owning entities. As can be imagined, there is no limitation on the ownership and/or control of the servers or data processing devices that store the blockchain structures.

The forwarding of the investor's investment to the second party owed the funds by the first party means that the second party is now partially paid. Once the first party pays the whole amount of the debt, the amount of the investor's investment and the return on that investment (as noted in the blockchain entry) are sent to the investor. The operator of the main server (i.e. the facilitator of the transaction) takes a portion of the payment and the rest of the payment is sent to the second party. The token sent to the investor is then either terminated or returned to the main server. In this manner, the investor receives his investment back along with the posted return, the second party receives most of the payment for the debt well before the first party pays the debt, and the first party's business is not disrupted. Of course, once payment has been made, all of the above is recorded in the blockchain data structure. This entry is then propagated throughout the network of blockchain holders.

As an example of the above process, one can assume an original debt of $100 owed by a first party to a second party and an expected payment within 90 days. The main server, after determining the risk associated with the debt, places a maximum of 80% to be tokenized with a rate of return of 5% based on the tokenized amount. This means a package detailing a required investment of $80 and a return of $4 within 90 days is sent out to prospective investors. (Alternatively, the main server may post this available package, along with other packages, to a freely available resource. This way, the public may freely avail of the service. Or, as yet another alternative, only a closed group of investors may be provided the opportunity to invest.) For this example, the facilitator (i.e. the operator of the main server and the entity that organizes and facilitates the transaction) will claim either a fixed price for the transaction or a percentage of the amount tokenized or a percentage of the total debt.

Once an investor decides to invest, a suitable data or electronic token is sent to the investor after the investor forwards the requisite $80. Preferably, this occurs well before the 90 day time frame when the first party's payment is expected. Once this $80 is received, it can then be forwarded to the second party as partial payment for the first party's debt. The second party thus receives partial payment for the debt at an earlier date than the projected 90 day payment window for the first party. The transaction details are, of course, stored in a new entry in the blockchain stored in the second party's server. Other second party servers replicate and validate this entry to ensure that all the blockchains in the network have a suitably validated copy of the entry.

In another implementation, instead of sending the full amount received from the investor to the second party, only a portion is sent to the second party. In this implementation, the facilitator holds back the return to be paid to the investor as well as the amount to be paid to the facilitator. Thus, in the example above, of the $80 received from the investor, the facilitator holds back the return of $4 and its share of (for this example) 5% of the tokenized amount. Thus, the facilitator holds back $8 and sends $72 to the second party.

In yet another alternative, instead of sending the full amount received from the investor to the second party, a different amount is withheld and the rest is sent to the second party. For this alternative, the facilitator holds back only its share of the tokenized amount. The return will be taken from the full amount of the debt once the first party pays. Thus, in the example above, of the $80 received from the investor, the facilitator holds back its share (5%) of the tokenized amount and the rest is sent to the second party. Thus, of the $80 received, $76 is sent to the second party. All the other amounts are to be paid out once the first party pays the full debt.

When the first party pays the outstanding debt, the amount of the investment, $80, is returned to the investor. The return of $4 is also sent to the investor. The operator of the main server receives a set percentage of the tokenized amount, e.g. 5% or $4. The rest of the funds, $12 (depending on the implementation details), is returned to the second party as the rest of the payment for the original $100 debt. The token sent to the investor is also either returned to the main server or rendered inactive or destroyed. The details of this transaction, along with the dates of the disbursement of the funds, are then entered in another entry in the blockchain. With that, the second party receives $92 in payment for the original $100 debt, with $80 (depending on the implementation as noted above) being paid well in advance of the first party's expected payment timeline of 90 days. The investor receives a 5% rate of return on his original investment of $80 and the operator of the main server (i.e. the facilitator of the system) receives, in this example, 5% of the tokenized amount. Of course, the facilitator's fees may be a fixed amount instead of being a portion or a percentage of the tokenized amount. As well, the above is provided as an example. The percentages for the rate of return, the amount to be tokenized, and the amount taken by the facilitator may all change depending on the implementation.

Regarding the blockchain data structure, this data structure is, essentially, a database of the transactions relating to the various tokenized debts of the various second parties. The entries in the data structure would detail the various debts that have been tokenized, the details of each token, the parties to the various debts, the investors for each debt, the rate of return, the expected payment date, what the actual payment date was, and the total debt and how much of that debt was tokenized. Each entry relating to the creation and dispatch (or deactivation) of a token is created by the main server 20. This entry is inserted into the blockchain and the entry is propagated throughout the various blockchain holders. These various blockchain holders replicate and validate each entry. In one implementation, each server operated by the second parties is a blockchain holder and these servers ensure that changes to the blockchain are propagated to the network and are validated.

Once the investor has, essentially, purchased the token, the token acts as a marker to claim the return on the investment as well as to claim the initial investment paid to the second party. Thus, whoever holds the token when the first party pays the outstanding debt collects not only the initial investment but also the return on that investment. Because of this portable nature of the token, the investor can sell the token to another investor. The token is therefore freely tradable between investors. Note that if the token could only be offered to a select group of investors, the exclusivity may be continued such that the token can only be sold to those within the select group of investors. Alternatively, of course, the token may be freely tradable to members of the general public.

It should be noted that the portability of the token allows for a market or an exchange of such tokens. Depending on the implementation, the main server (or a separate server) may be used to implement an online market for the buying, selling, and trading of tokens from tokenized debt. The participants may be those allowed to buy tokens or the market may be open to the general public. The facilitator may implement such a server and charge either a flat fee per trade/sale or they may charge a percentage of the sale price. It should be clear that the sale price for a token may not necessarily be the same price as the amount paid for the tokenized debt. In the example, the investor paid $80 for the token on a $100 debt in return for a $4 return in 90 days. The investor may thus sell the token for the initial outlay of $80 plus a return of, for example, $1, payable immediately. The investor can thus realize a return of $1 well before the 90 day payment date on an initial investment of $80. The buyer can then wait for the 90 day period to elapse to realize a return of $3 on an initial investment of $81.

Regarding implementation, the system may use existing blockchain technology. The Ethereum blockchain platform may be used to implement the blockchain portion of the present invention while a suitable user interface may be implemented to ensure ease of access for potential investors seeking to buy tokens. Similarly, the system may be set up to automatically send invoices from second parties to the main server so that these invoices (or a bundling of these invoices) may be tokenized and offered to investors.

It should also be clear that, in one implementation, the tokenization of debt is applied to debts owing to entities that offer online advertising services. In this implementation, the first parties are the advertisers and the debts incurred are for online advertising or marketing services provided by the second parties. Also, it is preferred if the records and entries added to the blockchain are encrypted to ensure that the details of the debt and that the identity of the actors involved are kept confidential.

It should further be clear that the blockchain provides an immutable ledger that holds the records for each transaction that tokenizes debt. Thus, the blockchain keeps a record of which debts have been tokenized, for how much, and who are the entities involved. As well, the blockchain details which of these tokenized debts have been retired, which tokens are still outstanding, and which tokens have been deactivated or destroyed.

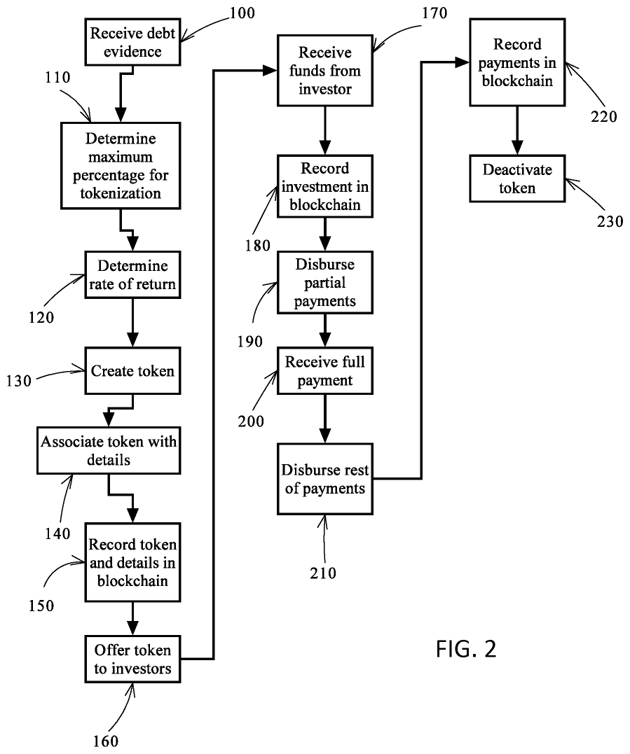

FIG. 2 is a flowchart detailing the steps in another aspect of the present invention. In the method of this aspect of the invention, the first step is that of receiving evidence of the debt (step 100). In this step, the invoice or group of invoices detailing the debt owed by the first party to the second party are received at the main server. The debt is then analyzed and a maximum amount or percentage of the debt to be tokenized is determined by the main server (step 110). Based on this maximum amount or percentage, the rate of return can then be determined by the main server (step 120). This rate of return can also be based on a number of other factors other than the maximum amount or percentage. Once the details regarding the token have been determined, the token is then created (step 130) and the details regarding that token are attached or associated with the token (step 140). The creation of the token and its details can then be recorded in the blockchain (step 150).

After the token has been recording in the blockchain, the token can then be offered to investors (step 160). After an investor has accepted the terms of the token, the investor then sends funds that are received (step 170) and this investment is recorded in the blockchain (step 180). The investment is then used to partially pay back the second party and part of the investment is withheld for other payments (step 190). Once the first party pays in full (i.e. the full payment is received in step 200), the rest of the payments based on the token and its details can be made (step 210).

This would include payments to the second party, the facilitator, the token holder, and possibly the investor. The payments are recording in the blockchain (step 220) and the token can then be deactivated and/or cancelled/destroyed (step 230).

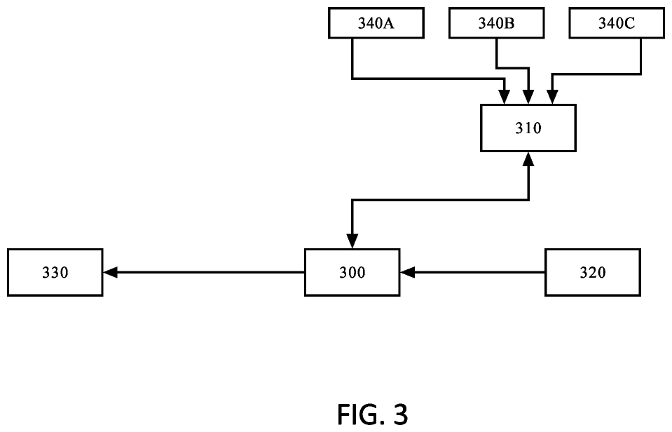

In one variant of the present invention, a server implements a token exchange that deals with investors as well as the trading and exchange of tokens generated by the main server. Referring to FIG. 3, a schematic diagram of the various components of this variant of the present invention is illustrated. As can be seen, a main server 300 communicates with a token exchange server 310, a server 320 for a first party, and a server 330 for a second party. The token exchange server 310 communicates with investors 340A, 340B, 340C. The token exchange server 310 records monies deposited by the investors 340A, 340B, 340C as investments into a pooled fund. The value of the pooled fund is determined periodically by an agreed upon fund accountant and may be dependent on the number of tokens held by the fund. As can be seen, the arrows in FIG. 3 denote the flow of funds as will be explained below.

In operation, the main server receives an indication of debt or debts between the first and second parties by way of their servers 320, 330 in the manner as explained above. The main server then receives data from the token exchange server as to the amount available as an investment by the investors. The main server then issues or creates a number of tokens based on this amount available. As an example, if a total of $100,000 was invested by the investors into the pooled fund, the main server could create 100,000 tokens with each token being given a value of $1. These created tokens are then sent to the token exchange server for storage while the records necessary to indicate the creation, storage, and ownership of these tokens are created and stored in the blockchain servers as noted above.

After the tokens are created and stored, the necessary funds are sent to the second party for partial payment of the debt in the manner noted above. The remaining funds are then held by the facilitator and, at this point, the service fee for the facilitator and the profit for the investors may be deducted from these remaining funds. Once the first party sends its full payment for the debt as noted above, the rest of the payment is forwarded to the second party as the rest of payment for the debt. The funds not used for payment of the debt can then be for another round and can be used to partially pay another second party. It should be fairly clear that the amount invested by the investors need not be exactly the amount necessary to address a specific debt as detailed in the example.

To clarify, at the end of every cycle noted above, the overall value of the tokens held in the token exchange server increases as the profit or return on investment for the investors is added to this value. This increase in the overall token value is detailed and noted by the fund accountant and is recorded on at least one blockchain entry. For even better clarity, an example will be provided assuming an investment of $100,000 by the investors into the pooled fund. Assuming a debt of $100,000 between the first and second parties and that a service fee of 5% of the total debt is charged by the facilitator and that a 5% (of the total debt, i.e. $5,000) profit for the investors is determined, the debt could be settled by an agreed upon rate of 90% of the total debt. Thus, of the $100,000 received by the facilitator from the investors (by way of the token exchange server), $70,000 can be sent to the second party. The 5% payment to the facilitator can be deducted from the remaining $30,000 along with the 5% profit for the investors, thereby leaving the facilitator with $20,000. The 5% profit for the investors can be set aside instead of being deducted.

Continuing from the above, once the first party pays the full $100,000 of the debt to the facilitator, the remaining $20,000 owing to the second party is paid, thereby retiring the debt. At this point, the facilitator would have the remaining $80,000 from the payment from the first party as well as the $20,000 from the original investment for a total of $100,000. In addition, the 5% profit ($5,000) set aside for the investors is also available such that the 100,000 tokens (originally issued at a value of $1 per token) now have a total value of $105,000 (i.e. $100,000 plus $5,000). This updated value can then be verified or assigned by the fund accountant as necessary and the new valuation can be reflected in another entry in the blockchain servers. Thus, each token would now have a value of $1.05 instead of the previous original value of $1.00.

It should be clear that the tokens may be stored in a digital wallet in the token exchange server on behalf of the investors and that the investors can, of course, review the value as well as the status of these tokens. Should an investor wish to sell his or her token/tokens, the facilitator can forward the funds from the amount it holds, if such funds are readily available. Conversely, if such funds are insufficient, these funds can be forwarded when available. As an example, if tokens worth $30,000 are to be withdrawn/redeemed in the time gap between the first payment to the second party and the full payment by the first party (i.e. when the facilitator only has $20,000 on hand), the facilitator may schedule the redemption of the tokens to be after the first party has paid. As an example, if the first party is expected to pay 90 days after the invoice from the second party is issued, the facilitator may schedule a redemption to be 120 days from the date of the invoice to ensure that the first party has paid. Once tokens have been redeemed, these tokens can be returned to the main server or destroyed or deactivated. Of course, such deactivation or destruction of specific tokens are listed and reflected in suitable entries in the blockchain as mentioned above.

Similarly, if an investor wishes to sell his or her tokens, the token exchange server can facilitate this by offering the available tokens to other investors in the group or to the public in general, as the case may be. It should be clear that the rules of the exchange may be different based on implementation and the investor group may be a closed group (i.e. tokens may only be sold/exchanged within the group) or it may be an open group (i.e. anyone can buy/sell the tokens).

The token exchange server may also have another function based on the details of the investment from the investors. Should the investors wish to invest an amount of cryptocurrency into the pooled fund, this amount of cryptocurrency can be forwarded to the token exchange server and this server can handle the conversion of the cryptocurrency into a regular currency as necessary.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object-oriented language (e.g.“C++”, “java”, “PHP”, “PYTHON” or “C #”). Alternative embodiments of the invention may be implemented as pre-programmed hardware elements, other related components, or as a combination of hardware and software components. Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A method for managing an accounts receivable debt between a first party and a second party, the debt being owed by said first party to said second party, the method comprising:
a) receiving an indication that said debt exists, said indication including an amount for said debt;
b) adding a record of said debt to a blockchain data structure;
c) determining a settlement price for said debt, said settlement price being less than a full amount for said debt;
d) settling said debt for said settlement price such that at least a portion of funds paid for said settlement price are funds invested by at least one third party;
e) receiving said full amount for said debt from said first party;
f) sending a portion of said full amount to said at least one third party as a predetermined return;
g) recording details and results of steps c)-f) in at least one entry in said blockchain data structure;
wherein said blockchain data structure and its contents are continuously replicated across a plurality of networked data processing devices.

2. The method according to claim 1, wherein said predetermined return is equal to a fixed percentage of said settlement price.

3. The method according to claim 1, wherein said contents of said blockchain data structure are encrypted.

4. The method according to claim 1, wherein said second party operates at least one of said plurality of data processing devices.

5. The method according to claim 1, wherein said debt is incurred for services rendered to said first party by said second party.

6. The method according to claim 5, wherein said services are advertising related.

7. The method according to claim 5, wherein said services are marketing related.

8. The method according to claim 6, wherein said services are related to online advertising.

9. The method according to claim 1, wherein said predetermined return is equal to a fixed percentage of said full amount of said debt.

10. The method according to claim 1, wherein said debt is settled before a specific period of time elapses from when said debt is incurred.

11. The method according to claim 1, wherein said specific period of time is, at most, 90 days.

12. The method according to claim 1, wherein a settlement of said debt is performed in at least two payments.

13. The method according to claim 1, wherein at least one token is generated to indicate said funds invested by said at least one third party.

14. A system for managing at least one debt between a first party and a second party, said second party being owed said debt by said first party, the system comprising:
a main server for:
receiving an indication that said debt exists, said indication including a full amount for said debt;
adding a record of said debt to a blockchain data structure;
managing at least one token having a monetary value such that transactions regarding said at least one token are recording in said blockchain data structure;
managing said debt between said first party and said second party such that said debt is settled for an amount that is less than said full amount for said debt;
wherein said at least one token indicates funds invested by at least one third party and said funds are used to at least partially settle said debt.

15. The system according to claim 14, wherein said blockchain data structure and its contents are continuously replicated across a plurality of networked data processing devices.

16. The system according to claim 14, wherein said main server communicates with at least one accounting computer for at least one of said first party and said second party to thereby receive said indication of said debt.

17. The system according to claim 14, wherein said at least one token is generated by said main server.

18. The system according to claim 14, wherein said at least one token is stored in a token exchange server on behalf of said at least one third party.

19. Computer readable media having encoded thereon computer readable and computer executable instruction that, when executed, implements a method for managing an accounts receivable debt between a first party and a second party, the debt being owed by said first party to said second party, the method comprising:
a) receiving an indication that said debt exists, said indication including an amount for said debt;
b) adding a record of said debt to a blockchain data structure;
c) determining a settlement price for said debt, said settlement price being less than a full amount for said debt;
d) settling said debt for said settlement price such that at least a portion of funds paid for said settlement price are funds invested by at least one third party;
e) receiving said full amount for said debt from said first party;
f) sending a portion of said full amount to said at least one third party as a predetermined return;
g) recording details and results of steps c)-f) in at least one entry in said blockchain data structure;
wherein said blockchain data structure and its contents are continuously replicated across a plurality of networked data processing devices.
